(19) United States
(12) Patent Application Publication
(10) Pub. No.: US 2020/0032991 A1
(43) Pub. Date: Jan. 30, 2020

(54) STAGE LIGHT CUTTING DEVICE

(71) Applicant: GUANGZHOU HAOYANG ELECTRONIC CO., LTD, Guangdong (CN)

(72) Inventor: Weikai JIANG, Guangdong (CN)

(21) Appl. No.: 16/338,467

(22) PCT Filed: Jun. 26, 2018
(86) PCT No.: PCT/CN2018/092931

§ 371 Date: Mar. 30, 2019

(30) Foreign Application Priority Data
Jun. 27, 2017 (CN) 201720756432.4

(51) Int. Cl. F21V 21/30; F21V 14/08; F21V 11/02

(52) U.S. Cl. CPC F21V 21/30; F21W 2131/406; F21V 11/02; F21V 14/08

(57) ABSTRACT

The utility model discloses a stage lighting cutting device, which comprising a cutter, cutter adjustment wheels for adjusting a cutting pattern of the cutter, a cover plate, an elastic fastening component provided on the cover plate and used for fixing the cutter adjustment wheels, and a connector matched with the cutter provided on the cover plate. The stage lighting cutting device of the utility model can plug and play, quickly realize the cutting of stage lighting, and is flexible and convenient to operate, preventing the cutter adjustment wheels from misoperation due to accidental contact or vibration of the stage light itself, so that a stable and reliable cutting pattern can be obtained.

### TECHNICAL FIELD

The utility model relates to the technical field of stage lighting cutting, in particular to a stage lighting cutting device.

### BACKGROUND ART

In the practical application of stage lights, the patterns projected by the lights need to be cut to meet the needs of different customers and situations, and a cutter needs to be configured on the device. In order to save costs and simplify the structure, a plug-and-play cutter which uses a manually adjustment structure to drive cutting blades to obtain the desired pattern is configured in many occasions. The adjustment structure only relies on the riveting tightness between its own components to prevent the cutting blades from moving after adjustment under normal conditions. However, the approach can be invalid with the increase in the number of use on the one hand, and on the other hand, the moving of the cutting blades can be caused by the accidental contact with the adjustment wheel or the vibration of the device itself, and leads to a pattern change.

### SUMMARY OF THE INVENTION

The utility model aims to overcome the defects of the prior art based on the above description, and provides a stage lighting cutting device which avoids misoperation. The stage lighting cutting device is simple in structure and convenient to operate, and can plug and play and effectively prevent the cutting blades from moving due to accidental contact or vibration of the device itself.

Another object of the utility model is to provide a stage light.

The technical scheme is as follows.

A stage lighting cutting device includes a cutter, cutter adjustment wheels for adjusting a cutting pattern of the cutter, a cover plate, and an elastic fastening component provided on the cover plate and used for fixing the cutter adjustment wheels, in which the cover plate is detachably matched with the cutter.

The utility model provides an elastic fastening component on the cover plate. When the cover plate is open, the cutter adjustment wheels are in a free state, and the operator can obtain the required cutting pattern by operating the cutter adjustment wheels. When the cover plate is closed, due to the fact that the cover plate is provided with the elastic fastening component for fixing the cutter adjustment wheels, the cutter adjusting wheels can be fixed to prevent the cutter adjustment wheels from moving, that is, preventing the cutter adjustment wheels from misoperation due to accidental contact or vibration of the stage light itself, so that a stable and reliable cutting pattern can be obtained.

In one of the embodiments, the cover plate is rotatably matched with the cutter, and a connector matched with the cutter is provided on the cover plate.

In one of these embodiments, the elastic fastening component is an elastic pressing strip. The elastic pressing strip is good in elasticity, low in cost and convenient to install, and when the cover plate is closed, the elastic pressing strip fixes and presses the cutter adjustment wheels tightly with the elasticity.

In one of the embodiments, the elastic pressing strip is a silicone elastic pressing strip, a rubber elastic pressing strip or an elastomer pressing strip.

In one of the embodiments, the elastic pressing strip has a thickness of 0.5 to 5 mm. The selection of the elastic pressing strip with a thickness of 0.5 to 5 mm can create a better fixing and pressing effect of the pressing strip on the cutter adjustment wheels.

In one of the embodiments, the cutter includes: a panel, a sandwiched plate, and a bottom plate, which are sequentially provided in a layered relationship through a connecting pole. A first light passing hole, a second light passing hole and a third light passing hole, which are used for a light beam to pass through, are respectively provided on the panel, the sandwiched plate and the bottom plate. Cutting blades and a linkage mechanism are provided on the panel, and the cutter adjustment wheels drive the cutting blades through the linkage mechanism to move and cover the third light passing hole to form the cutting pattern. The light beam can form a circular light spot through the first light passing hole, the second light passing hole and the third light passing hole, and the cutter adjustment wheels drive the cutting blades to move and cover the third light passing hole on the bottom plate through the linkage mechanism to form the cutting pattern so as to achieve the cutting of stage lighting.

In one of the embodiments, the number of the cutting blades is four and the cutting blades are symmetrically provided.

In one of the embodiments, a gasket is respectively provided between the panel and the sandwiched plate, and the sandwiched plate and the bottom plate. The panel, the sandwiched plate and the bottom plate can be assembled to have a compact structure by arranging the gasket.

In one of the embodiments, the number of the cutter adjustment wheels is eight. The eight cutter adjustment wheels are divided into four groups which respectively control the four cutting blades.

A stage light includes a light source and the stage lighting cutting device corresponding to the light source.

The beneficial effects of the utility model are as follows:

(1) In the utility model, the elastic fastening component for fixing the cutter adjustment wheels is provided on the cover plate of the cutter, which can prevent the cutter adjustment wheels from moving, that is, preventing the cutter adjustment wheels from misoperation due to accidental contact or vibration of the stage light itself, so that a stable and reliable cutting pattern can be obtained;

(2) The elastic pressing strip is selected to serve as the elastic fastening component, which has better elasticity, lower cost, and is convenient to install;

(3) The stage lighting cutting device of the utility model can plug and play, quickly realize the cutting of stage lighting, and is flexible and convenient to operate with obvious stability effect.

### BRIEF DESCRIPTION OF THE DRAWINGS

FIG. 1 is a schematic view of the overall structure of the stage lighting cutting device when the cover plate is in an open state.

FIG. 2 is a schematic view of the overall structure of the stage lighting cutting device when the cover plate is in a closed state.

FIG. 3 is an exploded view of the cutter.

### DESCRIPTION OF REFERENCE NUMERALS

1. cutter; 2. cutter adjustment wheel; 3. rotating shaft; 4. cover plate; 5. pressing strip; 6. connector; 11. panel; 12. sandwiched plate; 13. bottom plate; 14. connecting pole; 15. cutting blade; 16. linkage mechanism; 111. first light passing hole; 121. second light passing hole; 131. third light passing hole.

### Best Mode for Carrying out the Invention

In order to make the object, the technical scheme and the advantages of the invention more clear, the invention will be described in detail below with reference to the accompanying drawings and an embodiment. It should be understood that the embodiment described herein are merely exemplary and does not limit the scope of the invention.

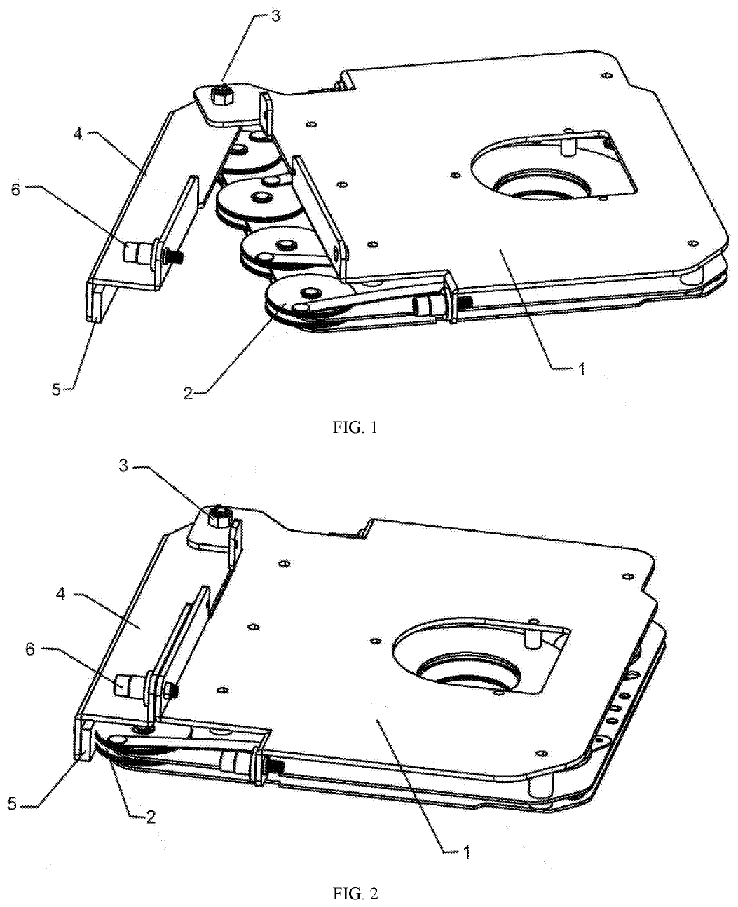

As shown in FIGS. 1 and 2, stage lighting cutting device of the utility model includes a cutter 1, cutter adjustment wheels 2 for adjusting the cutting pattern of the cutter, a cover plate 4, and an elastic fastening component 5 provided on the cover plate 4 and used for fixing the cutter adjustment wheels 2, in which the cover plate 4 is detachably matched with the cutter 1.

The cover plate 4 is rotationally matched with the cutter 1, and a connector 6 matched with the cutter is provided on the cover plate 4.

The cover plate 4 is connected with the cutter 1 through a rotating shaft 3. The elastic fastening component 5 is an elastic pressing strip. The elastic pressing strip can be a silicone elastic pressing strip, a rubber elastic pressing strip or an elastomer pressing strip, and is good in elasticity and fixes and presses the cutter adjustment wheels tightly with the elasticity. The cover plate 4 rotates around the rotating shaft 3 to realize opening and closing of the cover plate 4. When the cover plate 4 is open, the adjustment wheels 2 are in a free state, and the desired cutting pattern can be obtained by operating the adjustment wheels 2. When the cover plate 4 is closed, the pressing strip 5 on the cover plate 4 presses against the adjustment wheels 2 which are fixed by the elasticity of the pressing strip to prevent the adjustment wheels 2 from misoperation and to obtain a stable cutting pattern.

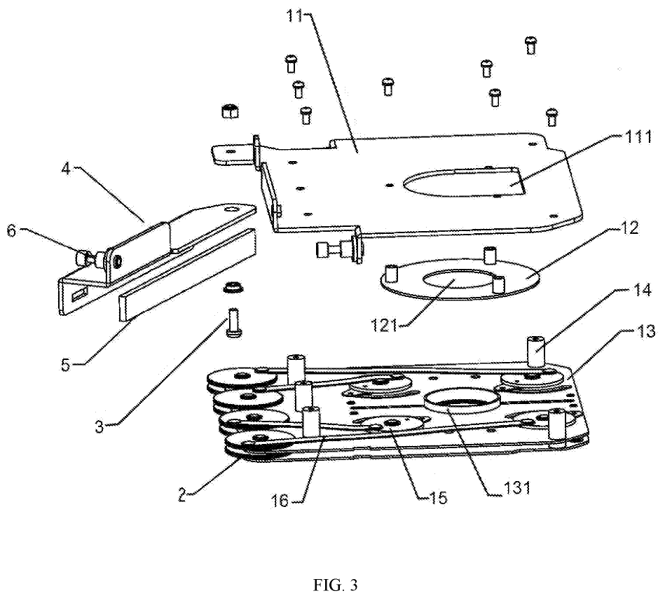

As shown in FIG. 3, the cutter 1 includes: a panel 11, a sandwiched plate 12 and a bottom plate 13, which are sequentially provided in a layered relationship through a connecting pole 14 wherein the connecting pole can be a riveting pole or a screw. A first light passing hole 111, a second light passing hole 121 and a third light passing hole 131, which are used for the light beam to pass through, are respectively provided on the panel 11, the sandwiched plate 12 and the bottom plate 13. Four cutting blades 15 and a linkage mechanism 16 are provided on the bottom plate 13, and the cutter adjustment wheels 2 drive the cutting blades 15 through the linkage mechanism 16 to move and cover the third light passing hole 131 to form the cutting pattern. The light beam can form a circular light spot through the first light passing hole, the second light passing hole and the third light passing hole, and the cutter adjustment wheels drive the cutting blades to move and cover the third light passing hole on the bottom plate through the linkage mechanism 16 to form the cutting pattern so as to achieve the cutting of stage lighting.

Further, a gasket is respectively provided between the panel 11 and the sandwiched plate 12, and the sandwiched plate 12 and the bottom plate 13. The panel, the sandwiched plate and the bottom plate can be assembled to have a compact structure by arranging the gasket.

In the embodiment, the number of the cutter adjustment wheels is eight, and the eight cutter adjustment wheels are divided into four groups which respectively control the four cutting blades.

The stage lighting cutting device provided by the embodiment can plug and play, quickly realize the cutting of stage lighting, and is flexible and convenient to operate with obvious stability effect.

The utility model also provides a stage light which includes a light source and the stage lighting cutting device corresponding to the light source. When the light beam emitted by the light source passes through the stage lighting cutting device, the stage lighting cutting device cuts and forms the light beam to achieve a target lighting effect.

The technical features of the above embodiment can be combined at random, and not all possible combinations of the technical features in the above embodiment are described in order to simplify the description. However, the combinations of these technical features should all be deemed within the scope of the specification as long as there is no contradiction among the combinations.

The above embodiment only expresses several implementations of the utility model. The descriptions thereof are specific and detailed, but they should not be construed as limiting the scope of the utility model. It should be noted that modifications and improvements can be made by those of ordinary skill in the art without departing from the spirit of the utility model, and all these modifications and improvements fall within the scope of the utility model. Therefore, the scope of the utility model should be subject to the appended claims.

1. A stage lighting cutting device, comprising:
a cutter (1),
cutter adjustment wheels (2) for adjusting a cutting pattern of the cutter,
a cover plate (4), and
an elastic fastening component (5) provided on the cover plate (4) and used for fixing the cutter adjustment wheels (2),
wherein the cover plate (4) is detachably matched with the cutter (1).

2. The stage lighting cutting device according to claim 1, wherein the cover plate (4) is rotatably matched with the cutter (1), and a connector (6) matched with the cutter is provided on the cover plate (4).

3. The stage lighting cutting device according to claim 1, wherein the elastic fastening component (5) is an elastic pressing strip.

4. The stage lighting cutting device according to claim 3, wherein the elastic pressing strip is a silicone elastic pressing strip, a rubber elastic pressing strip or an elastomer pressing strip.

5. The stage lighting cutting device according to claim 3, wherein the elastic pressing strip has a thickness of 0.5 to 5 mm.

6. The stage lighting cutting device according to claim 1, wherein the cutter (1) includes a panel (11), a sandwiched plate (12) and a bottom plate (13) which are sequentially provided in a layered relationship through a connecting pole (14); a first light passing hole (111), a second light passing hole (121) and a third light passing hole (131), which are used for a light beam to pass through, are respectively provided on the panel (11), the sandwiched plate (12) and the bottom plate (13); cutting blades (15) and a linkage mechanism (16) are further provided on the bottom plate (13); and the cutter adjustment wheels (2) drive the cutting blades (15) through the linkage mechanism (16) to move and cover the third light passing hole (131) to form the cutting pattern.

7. The stage lighting cutting device according to claim 6, wherein the number of the cutting blades (15) is four and the cutting blades are symmetrically provided.

8. The stage lighting cutting device according to claim 6, wherein a gasket is respectively provided between the panel (11) and the sandwiched plate (12), and the sandwiched plate (12) and the bottom plate (13).

9. The stage lighting cutting device according to claim 6, wherein the number of the cutter adjustment wheels (2) is eight.

10. A stage light, comprising: a light source and a stage lighting cutting device according to claim 1 corresponding to the light source.
